(19) United States
(12) Patent Application Publication
(10) Pub. No.: US 2002/0075544 A1
(43) Pub. Date: Jun. 20, 2002

(54) High-speed optical data network

(76) Inventor: Alex Mashinsky, New York, NY (US)

Correspondence Address: Walter G. Hanchuk, MORGAN & FINNEGAN, L.L.P., 345 Park Avenue, New York, NY, 10154, US

(21) Appl. No.: 09/738,547

(22) Filed: Dec. 15, 2000

(51) Int. Cl. H04B 10/20; H04J 14/00; H04B 10/12

(52) U.S. Cl. 359/173; 359/118

(57) ABSTRACT

A high-speed optical network is provided wherein transmitters and receivers operate under the control of an appropriate controller without the requirement for low-speed optical-electrical-optical (OEO) conversion devices. Through the use of appropriate multiplexing schemes and device controls, optical data signals are sent from transmitters to receivers without the requirement for intermediate address decoding and the concomitant signal regeneration necessitated by the use of low-speed OEO devices. Further provided are transparent optical data receivers which, under appropriate control, detect high-speed optical data with minimal or no diminution of the optical intensity of the underlying data signal. A transparent optical receiver may be utilized by removing a portion of the coating and cladding of an optic fiber and inserting the optical receiver at that location. Operating alone or with the receivers, the optical network of the present invention facilitates long-haul as well as local optical data transmission with minimal or no use of low-speed OEO devices and data signal regeneration, and can be further used to provide an alternate path for delivering large bandwidth data requested over electronic networks, such as the Internet.

### CROSS-REFERENCE TO RELATED APPLICATIONS

This application is related to co-pending U.S. patent application Ser. No. ______ , entitled “HIGH-SPEED OPTICAL DATA NETWORK WITH IMPROVED OPTICAL RECEIVER” filed in the name of A. Mashinsky on Dec. 15, 2000.

### FIELD OF THE INVENTION

The present invention relates generally to networks and more particularly to an optical network for high-speed voice and data transfer.

### BACKGROUND OF THE INVENTION

With the advent of the Internet, the universal requirement for data bandwidth has begun an almost exponential growth. Essentially non-existent as little as five years ago, the volume of Internet traffic was estimated to surpass voice traffic in 1999. In anticipation of increased market penetration as well as new applications such as streaming media and machine-to-machine transactions, it has been estimated that Internet traffic will grow an additional 20× to 30× times its current volume within the next two years. The majority of this traffic is carried by data networks, with wide-area networks (WANs) spanning large geographic areas while local-area networks (LANs) provide interconnections and data at point-of-use, such as in a business or home environment.

Today's WANs, whether optical or electrical or a combination of both, typically use one of several standard switching and routing protocols to move packets of information from source to destination through a series of intermediate switches. Data transfer over the Internet, for example, is based on packet switching technology using Internet Protocol (IP) to control the transmission of data in discrete packets. Packets are routed asynchronously from a source through various switches and paths and reassembled in appropriate order at a destination. Different sub-networks within a WAN may comprise different electrical/optical technologies. Paths within a WAN are often redundant, such that if a particular path is unavailable for any reason, an alternate path may be selected for any given data packet.

Optical network technologies are known in the art to have substantially higher bandwidth in comparison to electrical networks. Optical fiber technology is improving such that optical fiber pathways are able to support optical data transmission at ever-increasing rates of speed. In fact, it is well recognized that the basic data capacity of most optical fiber paths, commonly called pipes or links, dramatically exceed the capabilities of the networks in which they are implemented.

That is, a basic optical fiber path, or pipe, once installed, needs to be ‘lit’ with a data communications system in order to functionally carry data. One known optical data transmission system uses dense wave division multiplexing (DWDM) over synchronous optical network (SONET) equipment.

Today, the bandwidth of the optical fiber pipe typically exceeds the bandwidth of the rest of the network in which it resides requires. The use of processing elements, particularly optical-electronic-optical (OEO) devices to perform functions such as transmission, detection, switching and routing, is one limiting factor in the bandwidth of an optical network. Another factor involves the use and adaptation of conventional electrical network data transfer protocols, such as TCP/IP, for use in control of data flows on current optical networks. Such protocols fail to take advantage of the use of optical components and significantly increased data transmission speeds to effectuate optimized data transfer on an optical network.

The bandwidth of commercial optical fibers is currently doubling every nine-to-twelve months. See, “Next Generation Optical Networks—Scaling the Optical Internet,” Wit Soundview, Apr. 20, 2000. However, as new optical fiber is placed into an existing network it also becomes necessary to replace all of the associated processing elements with faster elements. While the cost of optical fiber is not excessive, the cost of periodically replacing and adding currently available optical routers and switches in typical optical network infrastructures, as well as replacing or installing related processing elements associated with the installation of new optical fiber paths, is prohibitively expensive. See, for example, U.S. Pat. No. 6,111,673 to Chang et al. which describes several different state-of-the art optical network technologies, the entirety of which is hereby incorporated by reference.

With reference to FIG. 1, for purposes of illustration, current optical networks 10 require the substantial use of optical-electrical-optical (OEO) devices to control the routing and delivery of optical packets. While high-speed OEO devices 12, such as terabit routers, are available that provide minimal delay and signal degradation operation, such high-speed OEO devices are expensive. They are, therefore, typically used sparingly throughout a network. More affordable lowspeed OEO devices 14, such as broadband optical cross-connect (OXC) and/or digital cross-connect (DXC) devices acting in conjunction with Add-Drop Multiplexers (ADMs), serve as the basic ‘building blocks’ of an optical network, functioning to route data on, off and within the network. Such devices substantially slow the operation of the network, while also degrading and hence requiring the constant regeneration of the optical signals conducted by the network.

The inclusion of multiple redundant paths in optical networks was originally necessitated by the bandwidth limitations of the optical fiber. However, as the bandwidth capacity of new optical fiber continues to increase on a logarithmic scale against time, it is the various processing elements described above that limit network bandwidth and require redundant network paths. This again results in very high infrastructure costs, not only to maintain the complex networks with multiple, redundant paths, but also to periodically replace processing components to accommodate faster components and new switching protocols.

In summary, optical networks in use today suffer significant limitations and drawbacks. They are limited in bandwidth by expensive, slow processing elements that require constant updating to accommodate higher speeds and new transmission protocols. Currently available processing devices make the ‘edge’ technology, or the placing of data onto and off of the network, expensive, thereby limiting the benefits otherwise recognizable by improvements to optical fibers. Current optical networks, furthermore, offer less than desirable functionality, particularly in high-bandwidth applications such as broadcast and streaming data applications, since the potential of existing optical network bandwidth is further unduly limited due to the use and adaptation of traditional electrical network protocols such as TCP/IP to control data flow on optical lines.

It would be desirable to provide a high-speed optical network not limited in bandwidth by the associated processing elements. It would be further desirable to provide such a network wherein the inherent bandwidth of the optical fiber pipes is the limiting factor in network bandwidth and may be realized with minimal use of switching elements and associated infrastructure. It would further be desirable if such a network were compatible with existing networks such that upgrades do not require the costly replacement of entire networks.

### SUMMARY OF THE INVENTION

It is an object of the invention to provide a new and improved optical switching network that cost-effectively utilizes the inherent high-bandwidth of optical fiber pipes.

It is a further object to provide such a network that is compatible with and can be used to expand the capability of existing optical networks.

It is a further object of the invention to provide such an optical switching network that can be upgraded by the substitution of higher-bandwidth optical pipes with only minimal changes in the associated processing elements.

According to one embodiment of the invention, an optical network includes at least first and second high-speed optical routers. A first optical fiber pipe directly connects the first and second high-speed optical routers. A second optical fiber pipe connects the second high-speed router to a user. An optical transmitter is connected to said first optical fiber pipe for transmitting an optical data signal into said first optical fiber pipe. An optical receiver is connected to the second optical fiber pipe for receiving the optical data signal. A controller is connected to the first and second high-speed routers, the optical transmitter and the optical receiver. The controller is operative with stored instructions to perform the functions of: (1) operating the transmitter to transmit the optical data signal onto the first optical fiber pipe at a selected time and modulated wavelength, (2) operating the second high-speed router to pass the optical data signal to the second optical fiber pipe at the selected time, and (3) operating the receiver to receive the optical data signal at the selected time. The optical data signal is transmitted from the transmitter to the receiver through the first and second optical fiber pipes and the high-speed router without the intervention of additional low-speed components.

According to another embodiment, an optical network includes at least first and second high-speed optical routers. A first optical fiber pipe directly connects the first and second high-speed optical routers. A second optical fiber pipe connects said second high-speed router to a user. An optical transmitter is connected to the first optical fiber pipe for transmitting an optical data signal into the first optical fiber pipe. A transparent optical receiver is connected to the second optical fiber pipe for receiving the optical data signal. A controller is connected to the first and second high-speed routers, the optical transmitter and the transparent optical receiver. The controller is operative with stored instructions to perform the functions of: (1) operating the transmitter to transmit the optical data signal onto the first optical fiber pipe at a selected time and modulated wavelength, (2) operating the second high-speed router to pass the optical data signal to the second optical fiber pipe at the selected time, and (3) operating the transparent receiver to receive the optical data signal at the selected time. The optical data signal is transmitted from the transmitter to the transparent receiver through the first and second optical fiber pipes and the high-speed router without the intervention of additional low-speed components.

According to a further embodiment, a method and apparatus for re-routing a data transmission between a transmitting party and a receiving party from an electronically-based network to an optically-based network is provided. In this embodiment, the transmitting party receives, from a requesting party, a request for a data transmission over an electronically-based network. The transmitting party determines whether the requesting party resides on an optical pathway, and if so, transmits the data transmission on the optical pathway to the requestor.

### DESCRIPTION OF THE FIGURES

These and other objects, features and advantages of the invention will best be understood by a consideration of the following detailed description of the invention when read in conjunction with the accompanying Figures, in which:

FIG. 1 is a diagrammatic view of a prior art optical network including multiple OEO devices;

FIG. 2 is a diagrammatic view of an exemplary wide area network;

FIG. 3 is a diagrammatic view of one embodiment of an optical network implemented in accordance with the present invention;

FIG. 4 is a diagrammatic view of one embodiment of a transparent optical receiver from the network of FIG. 2;

FIG. 5 is a plan view of an optical conduit supporting multiple optical receivers in accordance with one embodiment of the invention;

FIG. 6 is a diagrammatic view of an optical transmitter from the network of FIG. 2;

FIG. 7 is a flow chart showing a process for transmitting data in accordance with the present invention; and

FIG. 8 is a flow chart showing a process for receiving data in accordance with the present invention.

### DETAILED DESCRIPTION OF THE INVENTION

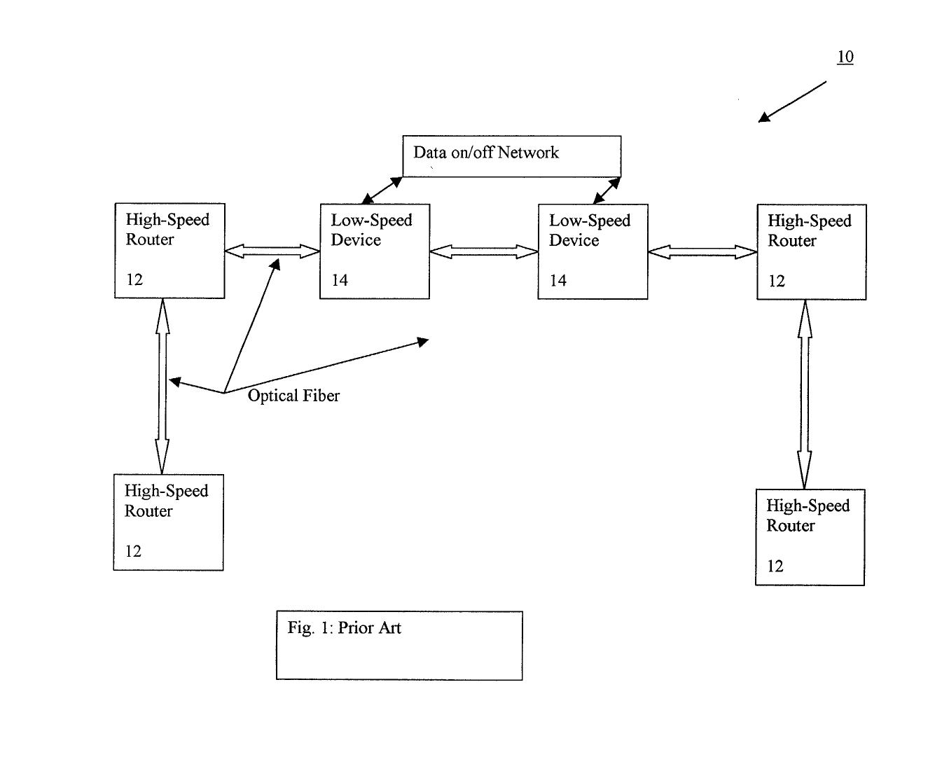

In accordance with the present invention and as discussed above, FIG. 1 is an example of an existing prior art optical network. Such a network may, for example, be an optical cable television network for providing digital interactive television functionality to a plurality of users with compatible cable set-top boxes. Other typical uses of such a network include high-bandwidth capabilities for transporting voice data, broadcast and streaming audio/video data as well as other, typically large, data files.

Fundamentally, in an existing network such as is shown, the low-speed OEO elements serve to route data on, off and through the network. They periodically terminate optical fiber pipes within the network, limiting the overall effective bandwidth of the network. While inexpensive in comparison to, for example, the high-speed OEO devices, low-speed OEO devices are endemic throughout existing networks. The cost of replacing large quantities of such devices at once in order to upgrade the network is, however, prohibitive.

Description of the Optical Network

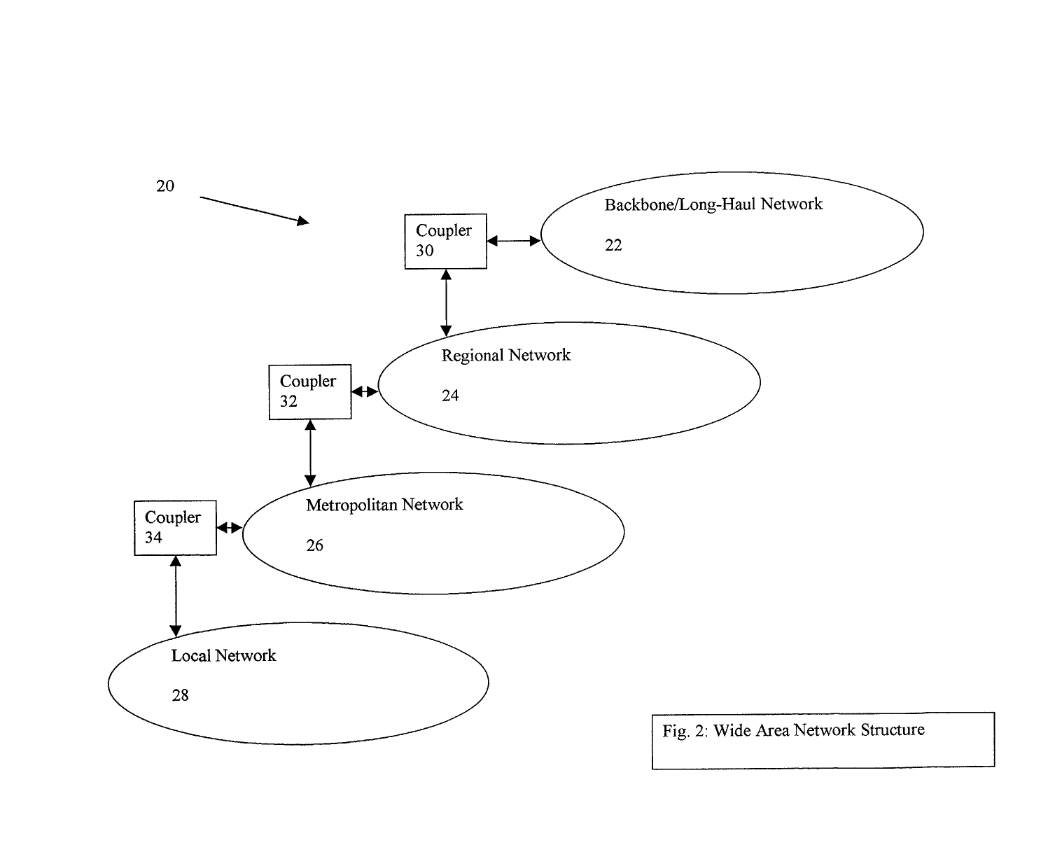

Referring now to FIG. 2, there is seen an exemplary embodiment of a WAN 20 including a backbone, or long-haul, network 22, a regional network 24, a metropolitan network 26 and a local network 28. Backbone network 22 and regional network 24 are connected by a high-speed router 30. A second high-speed router 32 connects regional network 24 and metropolitan network 26, while a third high-speed router 34 connects the metropolitan network and local network 28.

In a manner well know in the art, backbone network 22 provides long-haul network connections between regional networks such as regional network 24. Regional network 24 connects multiple metropolitan networks such as that shown as 26, which in turn connect local networks such as local network 28. A user, for example, may access WAN 20 through a local connection using, for example, a T1 line (not shown) in a manner well known in the art.

Backbone network 22 and regional network 24 typically provide lengthy runs of optical fiber pipe connected by high-speed routers. As the WAN integrates with local users through metropolitan network 26 and local network 28, the usage of low-speed OEO devices increases.

For example, in conventional optical networks, a user wishing to receive data via the local network must place an optical receiver on the optical fiber pipe. The optical receiver then detects an appropriate optical signal of a particular wavelength addressed for that receiver. Because a user's device or network can typically only utilize data in a traditional electronic format, the incoming optical signal must be converted using an ASIC protocol to generate a usable electrical signal. The converted electrical signal is then cached prior to transmission on the user's electrically-based device or network. This is because the data transfer rate on the optical side of the receiver will typically far exceed the transfer rate of the user's device or electrically-based network. The converted data is then transferred from the cache at an appropriate rate to the device or network.

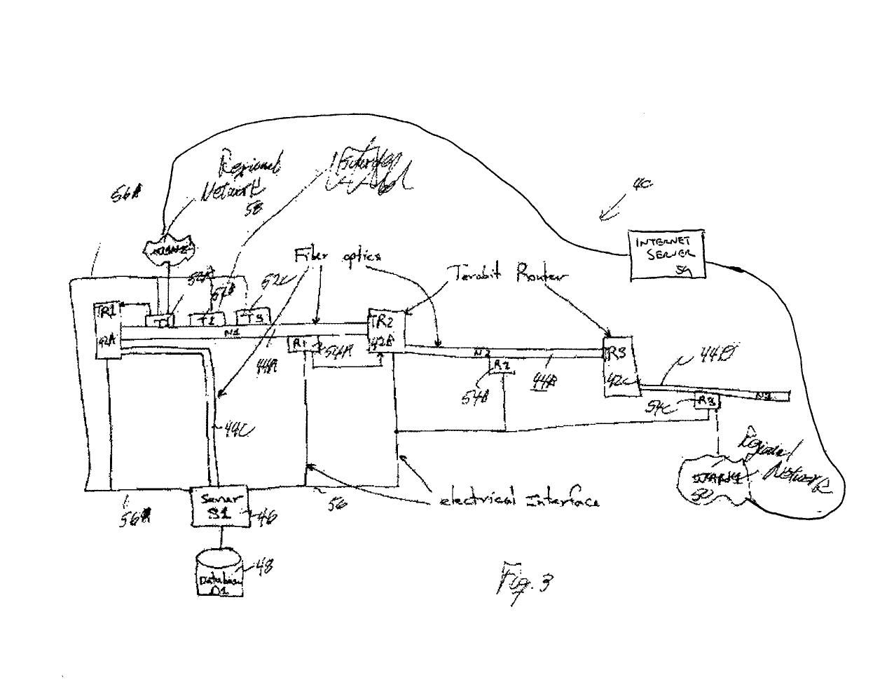

Referring now to FIG. 3, network 40 illustrates an exemplary backbone network configured in accordance with the present invention, including three high-speed routers 42A, 42B, 42C connected by a pair of optical fiber pipes 44A, 44B. It should be readily apparent that multiple or redundant routers may be used for each of high speed routers 42A, 42B, 42C and that data may be transmitted serially or in parallel. In the case of parallel data transmission, optical fiber pipes 44A, 44B may contain multiple optical fibers for accomplishing separate data transmissions. The high speed routers 42A, 42B, 42C may use a Kermit protocol or the like to divide a large data file into a plurality of smaller data files which may be transmitted on one or more of the optical fibers in the optical fiber pipes 44A, 44B.

A third optical fiber pipe 44C connects router 42A to a server 46 connected in turn to a database 48 which is used to monitor and schedule data transfer on the optical network. Server 46 may then coordinate scheduled transfer times with one or more of the high speed routers 42A, 42B, 42C or with a server outside the network, as described further hereinbelow. A fourth optical fiber pipe 44D is provided to connect router 42C to a regional network 50 through receiver 54C in a manner described in further detail below.

In accordance with one exemplary embodiment of the invention, three transmitters 52A, 52B, 52C are coupled to fiber optic pipe 44A. Exemplary embodiments of these transmitters are shown and described below. Three receivers 54A, 54B and 54C are coupled into fiber optic pipes 44A, 44B and 44C, respectively. Exemplary embodiments of these receivers are shown and described below. It will be understood that this configuration of network 40 is for purposes of illustration only. Numerous other configurations of the network will be readily apparent to those skilled in the art.

Server 46 is electrically connected to high-speed routers 42A-C, transmitters 52A-C and receivers 54A-C through a bidirectional electrical interface indicated at 56. It will be understood that electrical interface 56 may comprise an appropriate combination of direct and networked electrical connections in a manner conventional in the art. A second regional network 58 is connected to transmitter 52A.

While not shown, it will be understood that multiple transmitting sources, different ones of which are discussed below, are connected in a conventional manner to transmitters 52A-C. Similarly, and also in a conventional manner, multiple receiving users, including appropriate combination of other networks and end-users, are connected to receivers 54A-C. It should be further appreciated that that the transmitting and receiving sources may pass data in an encrypted format (i.e., using public key encryption) in order to protect the integrity of the network and the privacy of user data transfers over a publicly-accessible network embodiment.

Description of the Optical Receivers

Conventional optical receivers operate in a manner well known in the art. Typically, such receivers may include a photo diode for transducing the input optical signal into an electrical signal received on an optical fiber, a plurality of limit amplifier circuits which are connected in series to one another and which have offset compensation functions determined by controllable offset compensation time constants, respectively. The plurality of limit amplifier circuits amplify the electrical signal to produce an amplified and controlled electrical signal in dependency upon the offset compensation time constants controlled. The optical receiver further comprises adjusting circuits connected to the limit amplifier circuits for adjusting at least one of the offset compensation time constants to make the limit amplifier circuits produce the amplified and controlled electrical signal and an output terminal for producing the amplified and controlled electrical signal as the output electrical signal.

In accordance with one embodiment of the invention, receivers 54A-C comprise conventional optical receivers, such as those commonly produced by EPITAXX and JDS UNIPHASE. Such receivers are commercially available and significant advantages of the present invention can be realized using such receivers. Such receivers, however, are subject to recognized functional limitations. In particular, conventional receivers typically interrupt or diminish the magnitude of the received optical signal such that the signal must be regenerated in a manner well known in the art. Such regeneration slows the operation of the network. Such receivers and concomitant signal regeneration equipment typically require replacement in order to accommodate higher-speed optical fiber pipes as well as faster or different transmission schemes and protocols.

In accordance with a preferred embodiment of the present invention, receivers are provided that are capable of receiving optical signals in a transparent manner, that is, without impeding the transmission of the optical signal along the optical network. Such transparent receivers can detect optical signals using a low percentage of the light traveling through an optical fiber pipe such as to diminish or eliminate the requirement for slower, expensive signal regeneration components found in legacy opaque optical networks. As will be seen below, the use of such transparent receivers substantially diminishes the requirement for regeneration of optical signals, thereby increasing the speed and decreasing the cost of such a network. It should be understood that such transparent receivers may be configured to function within both a DWDM and/or a frequency division multiplexing (FDM) environment.

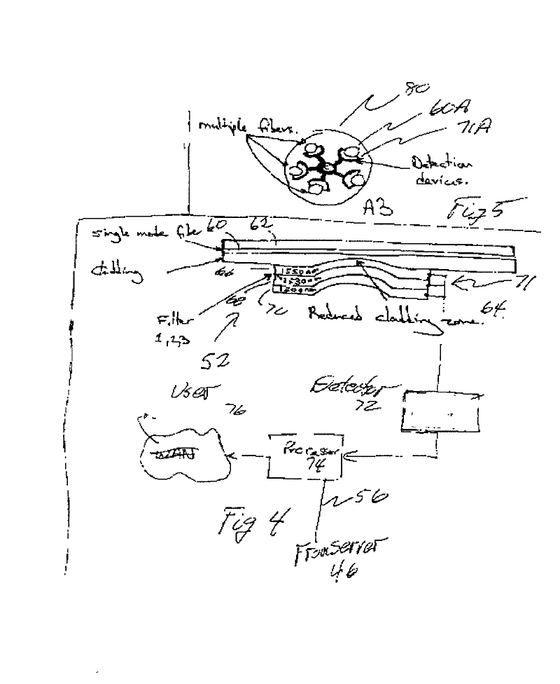

Referring now to FIG. 4, a diagrammatic view of one transparent optical receiver 52 is shown for receiving optical data from a conventional, single-mode optical fiber 60 surrounded by conventional cladding 62.

In accordance with the present invention, cladding 62 has been thinned in region 64 to permit a minimal amount of light to exit the cladding. The amount of the removed cladding should be sufficient to allow a portion of the optical fiber to evanescently couple with the a receiving device, while minimizing any loss of signal transmitted through the optical pipe. A series of optical filters 66, 68 and 70 are disposed in a stack 71 of overlying layers adjacent region 64, thereby enabling coupling of the optical pipe and the filters 66, 68, 70. In the present exemplary embodiment, filters 66, 68 and 70 may comprise Bragg filters and are selected such that filter 66 selectively filters, for example, 1550 nanometer (nm) wavelength light, while permitting other wavelength to pass through. Similarly, filters 68 and 70 may selectively filter 1530 nm and 1500 nm wavelength light, respectively. In one embodiment, these filters 66, 68, 70 may be stacked in order of descending filter wavelength in order to enable pass-through of received signals to the appropriate filters 66, 68, 70.

An optical detector 72 is connected to each of filters 66, 68 and 70 to detect optical data filtered by any one of the filters. Optical detector 72 is connected to a processor 74 which is in turn connected to a user 76. User 76 may comprise, for example, an end-user or a network connection or any other conventional recipient or processor of electronic data.

Electrical interface 56 is connected to processor 74 for supplying control signals from server 46 (FIG. 3) to the processor in a manner described in further detail below.

In operation, data of varying wavelength can be onto optical fiber pipe 62 using, for example, DWDM transmitters. When data is transmitted on pipe 62 for user 76, processor 74 receives a signal over interface 56 from server 46 indicating the timeframe and the wavelength of the data signal. The data is detected by one of filters 66, 68 and 70 in filter stack 71 and input to detector 72. Processor 74 then receives that data from detector 72, converts the signal to an electrical signal in a conventional manner, and provides the signal to user 76.

It will be appreciated that multiple DWDM signals of differing wavelength may be simultaneously transmitted, detected via filters 66, 68 and 70 and detector 72 and converted to electronic signals for one or more users 76. While a three-layer optical filter stack 71 has been shown for purposes of illustration, it will be apparent that more or less filters may be stacked to provide a receiver 52 capable of detecting more or less optical signals of differing wavelengths.

With reference now to FIG. 5, an optical fiber conduit 80 is shown including five optical fiber pipes 60A-E disposed symmetrically therein. Associated with each optical fiber pipe is an optical receiver 71A-E, respectively, of substantially the identical construction as described with respect to FIG. 4 above. Each optical fiber receiver is electronically connected (not shown) to detector and processor elements, in the manner described above, for detecting optical data of differing wavelengths.

Using the optical conduit construction of FIG. 5, multiple optical fiber pipes with individual receivers can be incorporated into a single conduit. It will be readily apparent that other geometrical configurations of optical fiber pipes in channels can be used to both increase and decrease the number of pipe/receiver pairs within a single conduit. With the addition of multiple pipe/receiver pairs within a single conduit, the optical receiving functionality associated with the use of optical fiber conduit 80 is substantially identical to that described above with respect to receiver 52.

Description of the Optical Transmitters

It will be understood that many conventional optical transmitters are known for transmitting wavelength-modulated optical data on an optical network. The present invention contemplates the use of any such high-speed transmitter capable of placing wavelength-modulated optical signals, preferably densely modulated signals, onto an optical network. One such transmitter is CIENA's MULTIWAVEMETRO DWDM device which is capable of point-to-point, star, ring and mesh network data transfer.

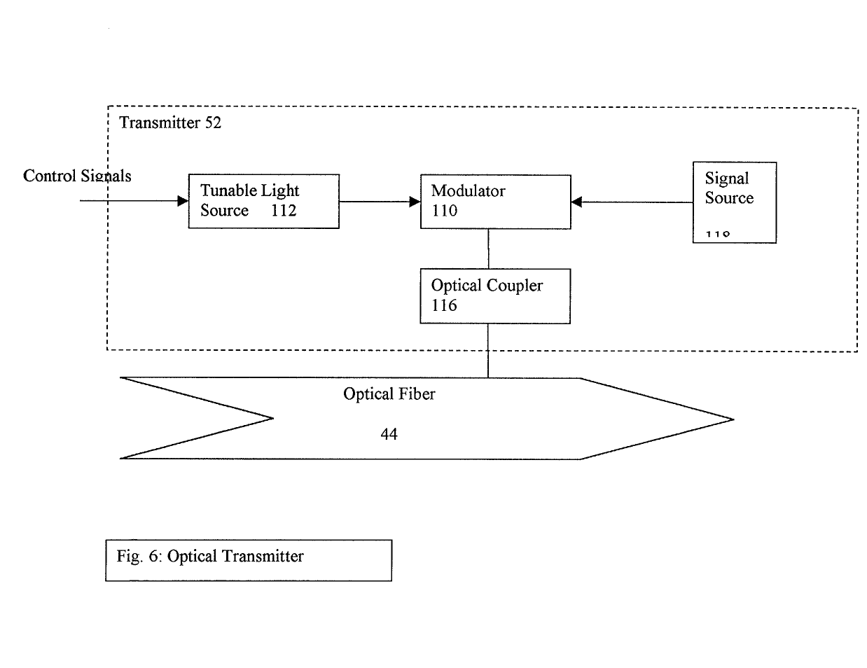

With reference now to FIG. 6, an exemplary optical transmitter 52 is shown for transmitting a modulated optical data signal within an optical network such as optical network 40 of FIG. 3. Optical transmitter 52 includes a modulator 110 for modulating a signal from a source 114 with frequency-tunable light from a tunable light source 112, such as a laser. The modulated signal is placed onto optical fiber 44 through a conventional optical coupler 116.

Operation of the Network

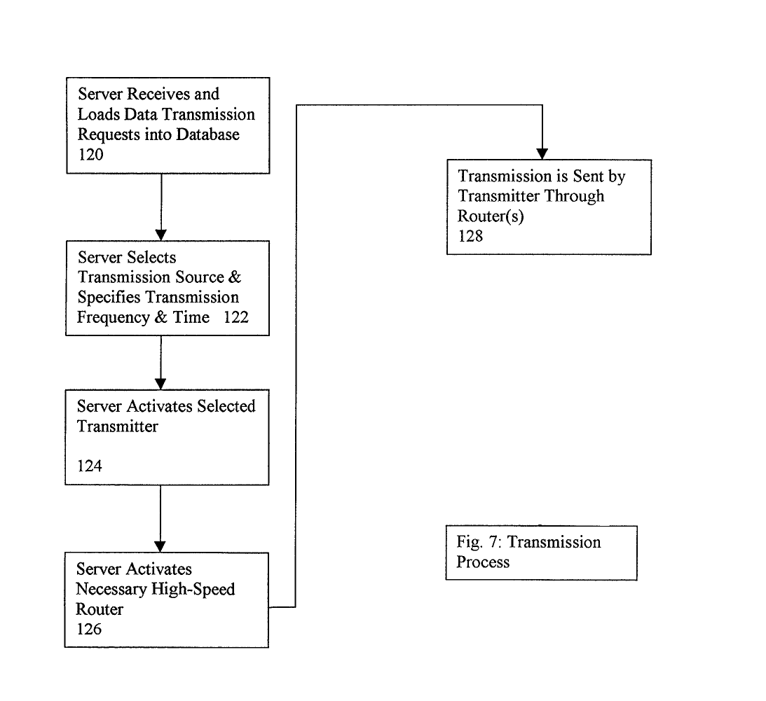

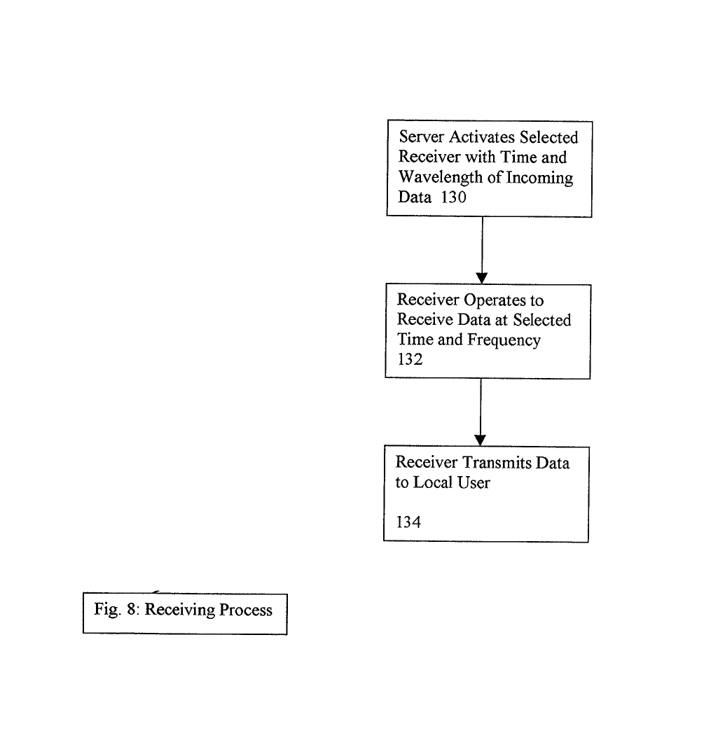

In operation, described with respect to FIGS. 7 and 8 and the system described above, server 46 operates in accordance with a program and data in database 48 to control transmitters 52A-C, routers 42A-C and receivers 54A-C to transmit optical data through network 40.

For purposes of illustration, any of the transmitters and receivers described above may be used, but the transparent receivers described with respect to FIGS. 4 and 5 are preferred for the advantages they confer.

With reference now to FIG. 7, in step 120 users of network 40 (not shown) send requests for data transmission in a conventional manner to server 46, which stores such requests in database 48 for processing. Such requests would include all necessary information including, for example, data size, transmission time and recipient.

As shown in steps 122-128, server 46, operating through electrical interface 56, provides control signals to the following devices as set out below.

Server 46 provides control signals to a selected transmitter 52A-C indicating necessary transmission information, including a data source, the time of transmission and the size of the data transmission . Operating in accordance with a selected transmission protocol and/or modulation format (i.e. OC12), server 46 will further indicate a frequency or frequencies at which the data will be transmitted, which in turn may be selected based on a frequency or frequencies at which an intended recipient may receive the data. If the recipient of the data is on the other side of a high-speed router 42A-C, such as receivers 54B and 54C in network 40, then server 46 provides the appropriate router(s) with the control signals necessary for the router to pass the transmitted data to a subsequent fiber optic pipe.

For example, assuming that a source/user connected to transmitter 52A wishes to broadcast a streaming video signal to recipient/users connected to each of receivers 54A, 54B and 54C, then server 46 will provide the necessary control signals to transmitter 52A to effect the transmission, the necessary control signals to router 42B to effect the routing from fiber optic pipe 44A to fiber optic pipe 44B, and the necessary control signals to router 42C to effect the routing of the signal from fiber optic pipe 44B to fiber optic pipe 44D. In this manner, the broadcast signal is made available to all of the necessary receivers.

With reference now to FIG. 8, a process for receiving data over network 40 is shown in steps 130-134.

At an appropriate time relative to the process of transmitting data described above, server 46 provides control signals to an appropriate receiver(s) 52A-C for receiving data. Specifically, the control signals include the frequency of the data signal and the timing of the data signal.

Responsive to the control signals, at the appropriate time the receiver 52 is configured to receive data of the expected frequency over the fiber optic pipe to which it is connected. With respect to the receiver shown in FIGS. 4 and 5, detector 72 and processor 74 are configured to receive data from the filter 66, 68 or 70 by which the data signal, based on its wavelength, will be detected. As described above, this is accomplished in a minimally intrusive way with respect to the diminution of intensity of the optical signal.

Continuing with the broadcast streaming data example described above, receivers, server 46 generates and transmits control signals over electrical network 56 to receivers 54A, 54B and 54C which cause the receivers to simultaneously receive the streaming broadcast data through the optical fiber pipes and routers described above.

While it has not been described in detail herein, it will be understood that data signals transmitted over network 40 include appropriate routing information, in accordance with appropriate protocols and standards, for subsequent electrical decoding and transmission to a subsequent end-user. Such addressing and protocols and standards are conventional in the art and will be understood by those skilled in the art to comprise one of many current and future-available schemes and formats.

There has thus been shown and described both new and improved optical network systems and new and improved transparent optical receivers. The network systems may function with any optical receiver but preferably use a transparent receiver.

By substituting high-speed optical devices for slower, more costly OEO devices, the present optical network system provides significant advantages and benefits over the prior art. Upgrades to the system do not require the extensive and expensive replacement of OEO components, significantly reducing the operational costs of the network system. The invention may be applied to upgrade existing legacy systems.

In one further example, a network, such as network 40, may be used as an alternate, high-bandwidth pathway for data that is currently transmitted over traditional electronically-based networks. Referring again to FIG. 3, it is contemplated that WAN 50 and regional network 58 may both be in electrical communication with, for example, a server 59 residing the Internet or World Wide Web. Server 46 may likewise be in communication with the Internet and server 59. In an exemplary embodiment, a user on WAN 50 may request a large data file or a streaming broadcast from a computer within regional network 58 through the Internet server 59. In such a case, server 46 may be configured to detect any file transfer requests placed with server 59 which exceed a predetermined threshold of size and/or approximate transfer time. The server 46 may further determine whether an alternate optical pathway, such as optical pipes 44A, 44B and 44C, between the requesting device and the receiving device is available. This may be accomplished, for example, by accessing a database of users or networks having access to an optical network. If both requesting device and the transmitting device are accessible over contiguous optical pathways, then the server 46 may schedule a transmission window on the available alternate optical pathway and direct server 59 to cancel transmission over the electronically-based network, while further directing the transmitting device to place the data on the optical pathway at the scheduled time. Thus, high bandwidth traffic may be automatically removed from the electronically-based network even when the request is made through such a network. This functionality, in turn, allows increased traffic capacity on the electronically-based network while fully utilizing the bandwidth potential of the alternate optical pathway. One of skill in the art may recognize that the transmitting and/or receiving parties may accomplish re-routing of data transmissions by performing the functions attributed above to server 46. It should be further understood that the criteria for placing a data transmission on the optical pathway may be based on the traffic on the electronically-based network, rather than on the size of the data transmission, for example, in kilobytes.

Because of the improved speed of the system described above, there will be the substantial elimination of the bandwidth constraints existing in prior systems, yielding increased utilization at lower costs. This will provide the opportunity to accommodate the anticipated increase in high-bandwidth data applications such as online television, streaming video and content data and other essentially unlimited continuous broadcasting platforms.

By moving the control signals out of the optical network and into the electronic control network, the speed and simplicity of the optical network is optimized, leaving the bandwidth of the optical pipe and high-speed switches available for data transmission.

The use of slower, more expensive routers is greatly diminished or eliminated in favor of much less expensive and more available optical transmitters and receivers with appropriate controls. This makes the cost of operating a backbone significantly less expensive. It also diminishes “on ramp and off ramp” costs, again replacing routers with less expensive transmitter/receiver components.

Additionally, with the use of applicant's transparent receivers, the described optical network system even further decreases the need for slow, relatively costly signal regeneration components. The invention thus enables significantly lengthy optical fiber pipes bounded only by high-speed routers at significantly spaced distances. Again, this has the effect of even further increasing the bandwidth and availability of the optical network system while diminishing operational costs.

The invention as described above and claimed below contemplates and covers these and numerous other modifications, enhancements and variations that, given the teachings of the invention, will now become apparent to those skilled in the art.

What is claimed is:

1. An optical network, comprising:
at least first and second high-speed optical routers;
a first optical fiber pipe directly connecting said first and second high-speed optical routers;
a second optical fiber pipe connecting said second high-speed router to a user;
an optical transmitter connected to said first optical fiber pipe for transmitting an optical data signal into said first optical fiber pipe;
an optical receiver connected to said second optical fiber pipe for receiving said optical data signal;
a controller connected to said first and second high-speed routers, said optical transmitter and said optical receiver; and
said controller operative with stored instructions to perform the functions of
operate said transmitter to transmit said optical data signal onto said first optical fiber pipe at a selected time and modulated wavelength,
operate said second high-speed router to pass said optical data signal to said second optical fiber pipe at said selected time, and
operate said receiver to receive said optical data signal at said selected time;
whereby said optical data signal is transmitted from said transmitter to said receiver through said first and second optical fiber pipes and said high-speed router without the intervention of additional low-speed components.

2. The optical network of claim 1 and further including:
multiple optical transmitters and receivers connected to said first and second optical fiber pipes and controlled by said controller;
said controller operative to control said multiple optical transmitters and receivers to simultaneously transmit and receive multiple optical data signals at different modulated frequencies.

3. An optical network, comprising:
at least first and second high-speed optical routers;
a first optical fiber pipe directly connecting said first and second high-speed optical routers;
a second optical fiber pipe connecting said second high-speed router to a user;
an optical transmitter connected to said first optical fiber pipe for transmitting an optical data signal into said first optical fiber pipe;
a transparent optical receiver connected to said second optical fiber pipe for receiving said optical data signal;
a controller connected to said first and second high-speed routers, said optical transmitter and said transparent optical receiver; and
said controller operative with stored instructions to perform the functions of
operating said transmitter to transmit said optical data signal onto said first optical fiber pipe at a selected time and modulated wavelength,
operating said second high-speed router to pass said optical data signal to said second optical fiber pipe at said selected time, and
operating said transparent receiver to receive said optical data signal at said selected time;
whereby said optical data signal is transmitted from said transmitter to said transparent receiver through said first and second optical fiber pipes and said high-speed router without the intervention of additional lowspeed components.

4. An optical network in accordance with claim 3 wherein said first optical fiber pipe comprises a long-haul optical fiber pipe; and further including
at least a second transparent optical receiver connected to said first optical fiber pipe.

5. A method for re-routing a data transmission between a transmitting party and a receiving party from an electronically-based network to an optically-based network, comprising:
receiving, from a requestor, a request for a data transmission over an electronically-based network;
determining whether the requestor resides on an optical pathway; and if so
transmitting the data transmission on the optical pathway to the requestor.

6. The method of claim 5, wherein said transmitting further comprises:
requesting a transmission window on the optical pathway; and
transmitting an indication of the transmission window to the requestor.

7. The method of claim 5, wherein said transmitting further comprises:
determining an optical frequency for the data transmission based on the requestor.

8. The method of claim 5, wherein said determining further comprises:
determining whether the requestor resides on the optical pathway when a size of the data transmission is greater than a predetermined value.

9. The method of claim 8, wherein the size is based on at least one of:
a size of the data transmission and a time required for the data transmission on the electronically-based network.

10. An apparatus for re-routing a data transmission between a transmitting party and a receiving party from an electronically-based network to an optically-based network, comprising:
means for receiving, from a requestor, a request for a data transmission over an electronically-based network;
means for determining whether the requestor resides on an optical pathway; and
means for transmitting the data transmission on the optical pathway to the requestor.
